(19) United States
(12) Patent Application Publication
(10) Pub. No.: US 2005/0220231 A1
(43) Pub. Date: Oct. 6, 2005

(54) Method for equalising and demodulating a data signal which is transmitted via a time-variant channel

(75) Inventors: Rainer Bott, Andechs (DE); Snjezana Gligorevic, Darmstadt (DE); Ulrich Sorger, Darmstadt (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: RHODE AND SCHWARZ GMBH AND CO. KG, MUENCHEN (DE)

(21) Appl. No.: 10/518,183

(22) PCT Filed: May 14, 2003
(86) PCT No.: PCT/EP03/05068

§ 371 Date: Dec. 16, 2004

(30) Foreign Application Priority Data
Jun. 24, 2002 (DE) 102 28 159.9

(51) Int. Cl. H04B 1/10

(52) U.S. Cl. 375/350

(57) ABSTRACT

According to the invention, in order to equalise and demodulate a data signal transmitted to a receiver via a time-variant channel, the scatterer coefficients (damping, delay and Doppler frequency) causing the signal distortions in the channel are determined from the received data signal in the receiver. In this way, the data signal id equalised and then demodulated.

The invention relates to a method for equalising and demodulating a data signal transmitted via a time-variant channel to a receiver.

Modern data transmission procedures via time-variant channels (fading channels) are susceptible to inter-symbol-interference (ISI) or inter-channel-interference (ICI). Channel estimation and equalisation are therefore required.

Conventional methods for channel estimation and equalisation are based upon an estimation of the channel impulse response as a function in the time and/or in the spectral domain. The channel impulse response is generally estimated directly using training sequences. The channel model upon which the estimation is based, can model either exclusively a single time function, or may include various paths with a different delay using the conventional tapped-delay model. These models, and therefore also the associated estimation methods, share the disadvantage that they do not take into consideration the geometry of the scatterers causing the distortion.

In the context of multi-carrier methods, e.g. OFDM, different Doppler shifts in the individual channel paths lead to ICI, i.e. a given carrier is influenced by adjacent carriers. If the real channel comprises several paths with a different Doppler shift, a conventional method with direct estimation of the channel via its impulse response cannot determine these different Doppler shifts. Accordingly, the ICI persists, and the receiver cannot achieve optimum reception and processing of the signal.

Conventional understanding of the time variation of the channel is based upon the assumption, that the impulse response of the channel between the training sequences changes only slightly or in a deterministic manner, and that the channel estimation and tracking algorithms used converge adequately.

With multi-carrier methods, e.g. OFDM, it is implicitly assumed that the channel is constant over a OFDM block.

For example, a method for the equalising DVB-T based on the assumption of constancy is described in Burow-R; Fazel-K; Hoeher-P; Klank-O; Kussmann-H; Pogrzeba-P; Robertson-P; Ruf-M-J “On the performance of the DVB-T system in mobile environments” IEEE GLOBECOM 1998.

With very rapidly changing channels, the methods described above require a rapid sequence of training sequences and/or lead to a poorer convergence of the channel estimation. With multi-carrier methods, constancy over a block, as mentioned above, is no longer guaranteed, and the performance of the methods decline considerably.

The object of the present invention is therefore to provide a method for equalising and demodulating a data signal transmitted via a time-variant transmission channel of this kind, which avoids the above disadvantages and limitations regarding the properties of the channel.

This object is achieved on the basis of a method according to the preamble of the independent claim by its characterising features. Advantageous further embodiments are defined in the dependent claims.

With the method according to the invention, the channel impulse response is no longer used for channel estimation. Instead, the so-called scatterer coefficients, that is to say, the complex-valued attenuation, the delay and the Doppler shift in the channel, are used. The reflections of a signal transmitted between a transmitter and a receiver caused by so-called scatterers have a causative influence on the quality of the transmission channel, as described for example, in the book by Raymond Steele, “Mobile Radio Communications”, Pentech Press, London, 1992, Section 2.3.1. Scatterers of this kind, such as buildings or vehicles, distort the data signal transmitted between the transmitter and the receiver. Scatterer coefficients in the data signal, which are attributable to the scatterer, can be determined in the receiver, and the distorted data signal can then be equalised and finally demodulated. According to the invention, the channel properties are therefore defined by these scatterer coefficients, which can be determined in a simple manner from the distorted data signals received on the basis of the following description.

The invention will be described below in greater detail with reference to schematic drawings of exemplary embodiments. The drawings are as follows:

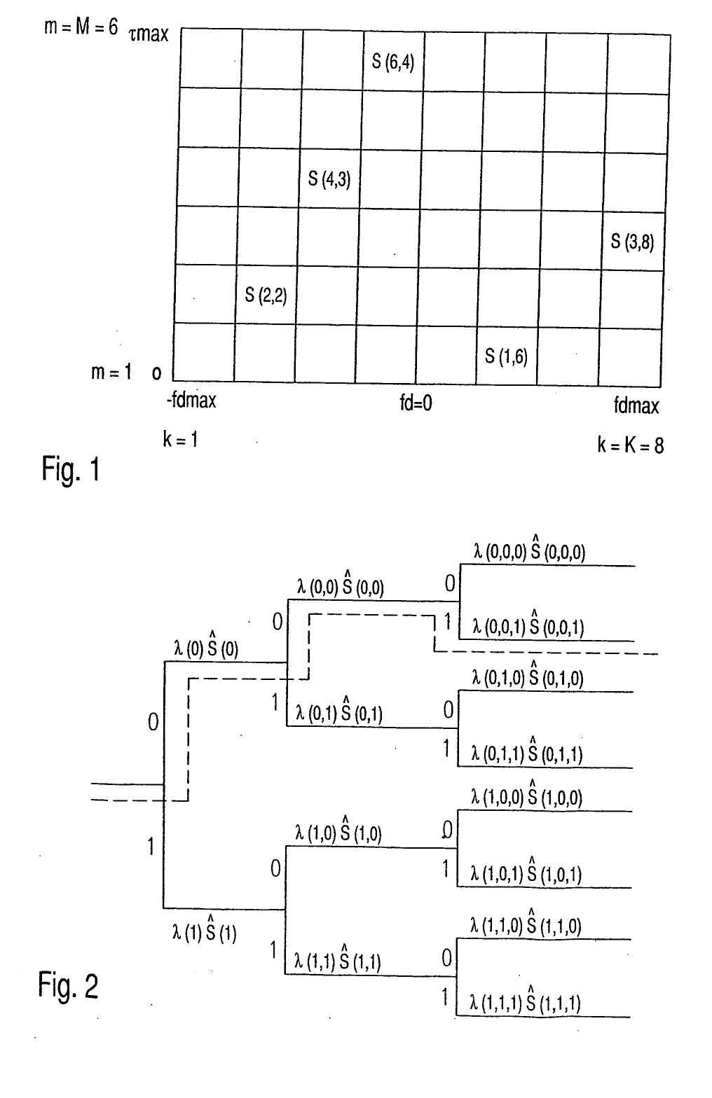

FIG. 1 shows the two-dimensional arrangement of the scatterer with the discretised Doppler frequencies and delays;

FIG. 2 shows a search tree;

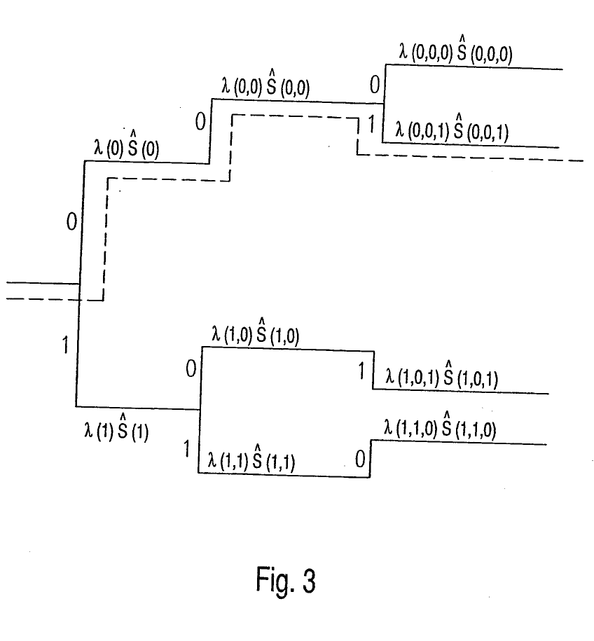

FIG. 3 shows a tree derived from the search tree of FIG. 2 taking the coding into consideration.

On the basis of a two-dimensional field, FIG. 1 shows the discretisation of the Doppler frequency f_{d} and the delay τ in the transmission channel for various scatterers. This graphic representation can be directly converted into a scatterer matrix S with the scatterer coefficients S(m,k), as used in the following equations (1) to (4). The coefficients of the matrix S represent the complex-valued attenuation values (amplitude and phase). The quantisation in the delay direction τ and in the Doppler shift direction f_{d} depends on the channel and the data transmission scheme. The maximum values K for the discrete, standardised Doppler shift and M for the discrete, standardised delay, result from the physical parameters of the channel. As can be seen, it is advantageous and, without restriction to generality, useful for the quantisation in the delay direction and the Doppler shift direction to be equidistant in each case. If no physical scatterer occurs for a given entry, then the corresponding scatterer in the matrix is simply set to zero.

FIG. 1 shows five scatterers, of which the indices correspond to the position in the scatterer matrix; in this context, the numbering begins with 1.

The symmetry with reference to the Doppler shift (positive and negative values) is not necessary a priori; it is dependent upon the channel.

As a result, this physical model takes into consideration the geometry of the channel propagation model instead of the pulse responses. This geometry, and therefore also the delay τ and the Doppler shift f_{d} allocated to the relevant scatterer, remains practically constant for sufficiently long periods, because the transmitter and/or receiver cannot move at an arbitrary velocity and/or cannot perform changes of movement at an arbitrary velocity.

By contrast, the impulse response of the channel can, in principle, change arbitrarily within the permitted physical boundaries. The discrete impulse response can be calculated from the complex scatterer coefficients S(m,k) to give:

$$h ( m , i ) = \frac{1}{\sqrt{N}} {\sum }_{k = - K}^{K} S ( m , k ) {ⅇ}^{j2π \frac{ki}{N}} \\ h ( i ) = {\sum }_{m = 0}^{M} h ( i , m ) \qquad ( 1 )$$

In this context, K is the maximum Doppler frequency occurring, m is the running index for the delay and i is the discrete running variable for time. h(i) is the resulting discrete impulse response of the channel in the time domain. It is observed over the length N.

The time-variant continuous impulse response of the channel h(τ,t) is physically bounded in τ and f_{d}.

Accordingly, for the scatterer function, S(τ,f_{d}) as the Fourier transformation of h(τ,t) over t and be set to S(τ,f_{d})=0 for τ≧τₘₐₓ, |f_{d}|≧f_{d,max}. By analogy with the sampling theorem, the impulse response h(τ,t) can therefore be presented completely through sampled values within the frequency domain, so that (1) is obtained as a discrete presentation of the channel.

The maximum likelihood approach for determining the scatterer-coefficient matrix S in the time domain is obtained by minimising the following expression according to the scatterer coefficients:

$${\sum }_{i = 0}^{N - 1} {‖ r ( i ) - \frac{1}{\sqrt{N}} {\sum }_{m = 0}^{M} d ( i - m ) {\sum }_{k = - K}^{K} S ( m , k ) {ⅇ}^{j2π \frac{ki}{N}} ‖}^{2} \qquad ( 2 )$$

In this context, it is implicitly assumed, that the transmitted data symbols d(i−m) are known. r(i) is a sample of the signal received.

The variables r(i) and d(i−m) are defined within the time domain.

The data symbols are either assumed to be known directly as a training sequence or they are determined from the signal received using the method described below.

The scatterer coefficients are preferably estimated in the time domain with data transmission schemes, which operate within the time domain. Such methods include, for example, single carrier methods with PSK or QAM modulation.

In the case of multi-carrier signals with known transmitted symbols, the estimation could also be carried out within the time domain, because the transmission signal is previously known.

The modulation scheme can be taken into consideration in equation (2), in that the data symbols d(i−m) carry the relevant signal form of the modulation type used, optionally with partial response pulse shaping. Channels with a large memory, i.e. with a long pulse duration, can be equalised by a corresponding choice of the maximum delay M. In this context, the duration of observation N is naturally also of a corresponding length.

An estimation can be implemented in the frequency domain in a similar manner to equation (2). In this context, the following equation is obtained:

$${\sum }_{n = 0}^{N - 1} {‖ R ( n ) - \frac{1}{\sqrt{N}} {\sum }_{k = - K}^{K} {\sum }_{m = 0}^{M - 1} D ( n - k ) S ( m , k ) {ⅇ}^{- j2π m \frac{n - k}{N}} ‖}^{2} \qquad ( 3 )$$

The variables R(n) and D(n−k) shown in (3) are defined within the frequency domain.

The scatterer coefficients are preferably estimated in the frequency domain with data transmission schemes, which operate within the frequency domain. Such methods include, for example, multi-carrier schemes such as OFDM with the DVB-T method.

As for an estimation within the time domain, the data symbol D(n−k) can carry the signal form of the modulation type used, presented in this context, within the frequency domain.

As can be seen from equations (2) and (3), for the estimation of scatterer coefficients, the transmitted data are assumed to be known. The estimation is carried out over N samples in the time domain and/or N spectral components in the frequency domain.

Normally, at the beginning of a data transmission, a known symbol sequence is transmitted, which is used for synchronisation. Following this, in the case of unknown data sequences, the receiver must track the estimation of the channel and/or, with a new transmission of synchronisation information or training symbols, re-estimate and/or adapt the convergence behaviour of the estimation and tracking algorithm.

Estimation of the scatterer coefficients is preferably carried out by means of a recursive Kalman algorithm or an RLS algorithm, in which, after initialisation with the known symbol sequence, the channel is tracked with initially unknown sequences. An RLS algorithm for determining the scatterer coefficients reads, for example, as follows:
K(i)=P(i−1)·D^{T}(i)(D(i)·P(i−1)·D^{T}(i)+W(i))⁻¹
P(i)=P(i−1)−K(i)·D(i)·P(i−1)
e(i|i−1)=r(i)−D(i)·Ŝ(i−1)
Ŝ(i)=Ŝ(i−1)+K(i)·e(i|i−1) (4)

In this context, K(i) is the Kalman-gain, P is the prediction state covariance matrix, D is the data matrix, which results from (2) and/or (3), W is the noise-covariance matrix and Ŝ is the vector of the estimated scatterer coefficients, which results from the arrangement of the scatterers in a linear vector from the matrix S. r(i) is the received, sampled signal value (time or frequency domain), i is the index in the time or frequency direction.

The methods of recursive estimation are per se known and have been described, for example, in S. Haykin, “Adaptive Filter Theory”, 1^{st} Edition, Englewood Cliffs, N.J., Prentice Hall 1986.

It should also be noted that the RLS algorithm described is only mentioned as one example of a large number of different embodiments.

After the initial estimation of the channel using training symbols, a maximum likelihood (ML) approach is selected, in which minimisation is carried out in the equations (2) and (3) for unknown data sequences over all possible data sequences and all possible arrangements of scatterers.

A tree-search procedure can advantageously be used in conjunction with the channel estimation. In this context, starting from the channel estimated with reference to the training sequence, a pathway in a tree is built up by the receiver for each of the potential data sequences. A channel estimation is carried out with the estimation of the scatterers for each of these pathways, and a metric is calculated according to equation (2) and/or (3). The data sequence with the best metric is presented as the data sequence which has probably been received. Because of the ML approach, the metric is known as a ML-metric.

Instead of the metrics according to (2) and/or (3), which are determined in one block over the entire observation interval N, an incremental metric may also be used. This takes equation (4) into consideration as follows:
Λ(i)=Λ(i−1)+e(i|i−1)·(r(i)−D(i)^{H}Ŝ(i)) (5)

This tree-search procedure is illustrated schematically in FIG. 2 for binary symbols, λ(x, . . . y) denotes the metric for the assumed symbols x . . . y, Ŝ denotes the matrix for the scatterers determined for the relevant pathway. The number of indices indicates the depth of the tree; in the example, up to a maximum of three. The additionally marked pathway characterises the best pathway selected via the metric at the moment.

The algorithm described is a soft output algorithm, which, alongside the demodulated data, can also present a quality measure for the demodulation in the form of a metric. Accordingly, it is possible to present not only the data sequence determined as the most probable, but also less probable sequences. Processing stages, such as decoders connected downstream in the receiver, can contain additional information, which has a positive influence on the quality of reception.

In this manner, several data sequences can continue to be processed in the subsequent processing stages, a decision about the actual sequence received being made only afterwards.

Moreover, the method can advantageously be combined with a convolutional code or a block code as a single code or internal code of a concatenated code structure.

Presentation of convolutional codes and block codes in the form of tree structures is already known. A code acts on the above-mentioned tree structure in such a manner that not all pathways, which would be possible if the code were not taken into consideration, actually exist. Accordingly, when code information is included, a tree of this kind will not contain all pathways.

This combination provides combined channel estimation, equalisation, demodulation and decoding, which is referred to as “sequential decoding”. Although this method is already known, its use in conjunction with the determination of the scatterer coefficients is novel.

A tree derived from the example of FIG. 2 is illustrated in FIG. 3. Comparison of the two trees shows that pathways determined by the code are non-existent.

With multiple-value data symbols and/or long data sequences, very many pathways occur during the course of processing, for each of which the metrics and scatterer matrices as well as other auxiliary parameters for the algorithms must be calculated and stored. The number of pathways can be reduced in order to lessen the burden of calculation and memory requirement. In this context, the total number of pathways is limited to a maximum number, which depends on the available calculation capacity and the memory requirement of the receiver. In this context, the known metric-first, breadth-first or depth-first algorithms can be used.

Known special methods for equalisation with a tree-search procedure have disadvantages in the context of channels with long impulse responses, in which a large proportion of the energy of a data symbol is disposed at the end of the impulse response, so that this energy is not included in the estimation of the received symbol. In this context, the entire impulse response must either first be waited for with a corresponding, additional delay, or it must be taken into account through additional estimation methods with a modelling of these influences as noise. With the first variant, many additional pathways occur, which have to be included in the computation, even if they are rejected afterwards. If the method is used for general and unknown channels, the computations must always use the maximum channel impulse lengths, and the algorithm must therefore be designed for this in advance.

The method according to the invention does not avoid these disadvantages a priori. However, since the channel is modelled with reference to the scatterers, the maximum occurring delay, and therefore the dimension of the scatterer matrix, can be measured by determining the relevant scatterers. While this maximum length must always be taken into consideration in the context of the known methods, the method according to the invention allows the maximum delay of the channel to be approached in an adaptive manner, and the necessary delay in demodulation and decoding is adjusted accordingly. A long additional delay in the demodulation and coding becomes necessary only in special channels, in which significant scatterers occur with long delays. Since the geometry of the scatterers does not change abruptly, the dimension of the scatterer matrix can be increased adaptively if a scatterer with long delay occurs. Conversely, if a scatterer of this kind disappears, the dimension of the matrix can be adaptively reduced.

The decision can be represented in terms of a formula based on (2):

$$d \hat{} ( 0 … N - L - 1 ) = \frac{arg min}{\begin{matrix}d ( 0 … N - L - 1 ) d ( N - L … N - L ) \\ S ( m , k )\end{matrix}} ( {\sum }_{i = 0}^{N - 1} {‖ r ( i ) - \frac{1}{\sqrt{N}} {\sum }_{m - 0}^{M} d ( i - m ) {\sum }_{k = - K}^{K} S ( m , k ) {ⅇ}^{j2π \frac{ki}{N}} ‖}^{2} ) \qquad ( 6 )$$

In this context, L is the necessary delay. The minimum is determined for all possible data hypotheses d and all possible scatterers S.

In addition to optimising the dimension of the scatterer matrix with reference to delay, the maximum Doppler shift occurring can also be optimised.

In the context of equalising and demodulating single carrier methods, the transmitted data can only cause ISI in the time direction, that is to say, data transmitted in the past influence data transmitted at a later time.

Because of the ICI occurring in the frequency domain when receiving multi-carrier signals, e.g. OFDM, a given carrier can be influenced by adjacent carriers both in the positive and also negative frequency direction.

It must also be taken into account that a cyclic continuation of the carriers occurs in the frequency domain. This cyclical continuation can be taken into consideration in the data matrix D, by defining the data symbols D(n−k) with a negative index occurring in equation (3).

As in the context of considering long delays in the channel impulse response when processing in the time domain, this influence can be taken into account and compensated by including “future” events, that is, data of higher frequencies, through a corresponding delay of the decisions. Here also, the scatterer matrix can be varied adaptively.

An analogous decision for multiple carrier methods is achieved if (3) is used in (6).

The method described can also operate without initialisation based on training sequences. In this case, processing is initialised with default values, e.g., the matrix P from (4) is pre-defined as the unity matrix, and the scatterer vector Ŝ is initialised at zero. The algorithm will then generally converge more slowly. Furthermore, all possible starting configurations for the data sequence must be included.

1. Method for equalising and demodulating a data signal transmitted using a single-carrier or multi-carrier data-transmission procedure via a time-variant channel to a receiver, wherein the scatterer coefficients including attenuation, delay and Doppler frequency in the received data signal, which cause signal distortion in the channel, are measured in the receiver, and the data signal is equalised with the scatterer coefficients determined in this manner and then demodulated with them.

2. Method according to claim 1, wherein the measurement of the scatterer coefficients and the equalisation of the data signal take place within the time domain.

3. Method according to claim 2, wherein its use is in the context of single-carrier data transmission schemes.

4. Method according to claim 2, wherein its use is in the context of multi-carrier data transmission schemes for receiving known data sequences.

5. Method according to claim 1, wherein the measurement of the scatterer coefficients and the equalisation of the data signal take place within the frequency domain.

6. Method according to claim 5, wherein its use is in the context of multi-carrier data transmission schemes.

7. Method according to claim 1, wherein the scatterer coefficients are measured via a maximum likelihood criterion.

8. Method according to claim 7, wherein the maximum-likelihood criterion is determined from the Euclidian distance between the received signal, the scatterer coefficients and the signal data demodulated in the receiver.

9. Method according to claim 1, wherein a first measurement of the scatterer coefficients is implemented with the assistance of a known data sequence.

10. Method according to claim 1, wherein the first measurement of the scatterer coefficients is implemented block-wise over an entire data sequence.

11. Method according to claim 1, wherein a Kalman algorithm is used iteratively for the measurement of the scatterer coefficients.

12. Method according to claim 1 wherein wherein a recursive-least-square algorithm is used iteratively for the measurement of the scatterer coefficient.

13. Method according to claim 9, wherein the scatterer coefficients determined in the first measurement are used for receiving the associated user data, wherein the data are equalised and demodulated block-wise over an entire data sequence, and the scatterer coefficients is determined in the first measurement are corrected with reference to the data equalised and demodulated in this block-wise manner.

14. Method according to claim 1, wherein the scatterer coefficients determined in the first measurement are used for receiving the associated user data, wherein the scatterer coefficients determined in the first measurement are corrected according to a Kalman or recursive-least-square algorithm with reference to the data equalised and demodulated.

15. Method according to claim 13, wherein a tree-search procedure is used for correction of the scatterer coefficients and for data demodulation, wherein, the scatterer coefficients and metrics are measured, in each case, for all possible data sequences, and those data sequences, which provide the best maximum-likelihood-metric, are then selected from the tree structure.

16. Method according to claim 15, wherein the scatterer coefficients corresponding to the selected best data sequences are used for subsequent equalisation and demodulation.

17. Method according to claim 15, wherein selection of the data sequences is carried out block-wise for the entire data sequence observed.

18. Method according to claim 15, wherein the data sequences are selected after a predetermined pathway depth of the tree has been reached.

19. Method according to claim 15, wherein a metric-first algorithm is used in the tree-search procedure.

20. Method according to claim 15, wherein a breadth-first algorithm is used in the tree-search procedure.

21. Method according to claim 15, wherein a depth-first algorithm is used in the tree-search procedure.

22. Method according to claim 15, wherein the pathway depth and/or the number of pathways is varied adaptively in the tree-search procedure according to the scatterer coefficients determined.

23. Method according to any one of claim 15, wherein the metric value is also presented in the output of the demodulated data sequence.

24. Method according to claim 15, wherein in addition to the data sequence with the best maximum-likelihood metric, other, next-best data sequences with a next-best-likelihood metric are also presented.

25. Method according to any one of claim 15, wherein when receiving data signals coded according to a code, exclusively data sequences corresponding to valid code words are included in the tree-search procedure.

26. Method according to claim 25, wherein in addition to taking the code into consideration, a Viterbi algorithm or APP algorithm is used in the tree-search procedure.

27. Method according to claim 1, wherein the first measurement of scatterer coefficients is implemented exclusively with unknown useful data sequences, and that default values are used in the initialisation of the algorithm instead of the training and synchronisation sequences.

28. Method according to claim 7 wherein the maximum number of scatterer coefficients to be included in an algorithm is adapted in each case on the basis of the scatterer coefficients previously determined.
